(19) United States
(12) Patent Application Publication
(10) Pub. No.: US 2003/0039113 A1
(43) Pub. Date: Feb. 27, 2003

(54) Lighting unit

(75) Inventors: Jochen Murr, Bornheim (DE); Klaus Wammes, Bechtheim (DE)

Correspondence Address: SUGHRUE MION, PLLC, 2100 Pennsylvania Avenue, NW, Washington, DC, 20037-3213, US

(73) Assignee: SIEMENS AKTIENGESELLSCHAFT

(21) Appl. No.: 10/192,591

(22) Filed: Jul. 11, 2002

Related U.S. Application Data
(63) Continuation of application No. PCT/DE01/00115, filed on Jan. 12, 2001.

(30) Foreign Application Priority Data
Jan. 14, 2000 (DE) 100 01 412.7

(51) Int. Cl. F21V 7/04

(52) U.S. Cl. 362/31

(57) ABSTRACT

A flat lighting unit that is particularly easy to produce having high luminous efficiency and compact dimensions. The lighting unit is provided with a light-guiding plate (1), which includes volume elements (2) with different refractive indices for scattering the light. The plate (1) forms a light-emitting surface (3) on one side and has recesses (4) on the other side, facing away from the light-emitting surface. The recesses are distributed over the surface of the light-guiding plate and each recess has an individual light source (5) embedded therein.

This is a Continuation of International Application PCT/DE01/00115, with an international filing date of Jan. 12, 2001, which was published under PCT Article 21(2) in German, and the disclosure of which is incorporated into this application by reference.

### FIELD OF AND BACKGROUND OF THE INVENTION

Flat lighting units that emit light uniformly over a relatively large light-emitting surface are used, in particular, as backlights for displays with non-luminous display elements, e.g., liquid crystal displays.

In so-called backlit displays, light sources, particularly fluorescent tubes, are arranged behind a diffusing screen or foil (diffuser). The greater the distance between each of the light sources, the greater the distance must be between the light sources and the diffuser, in order to obtain an optimally uniform distribution of light by the diffuser. Increased distance between the light sources and the diffuser can result in a relatively large overall height of the lighting unit. In addition, failure of one of the light sources invariably causes the overall light emitted from the lighting unit to be distributed unevenly. Also, the diffuser absorbs light, reducing luminous efficiency.

In so-called edge-lit backlights, the light sources are arranged in the area of at least one narrow side of a light-guiding plate, which emits light uniformly distributed across one of its main sides. For this purpose the light-guiding plate can be provided with a lattice-type structure on its side facing away from the main side. This lattice-type structure uniformly distributes light in the plate subject to total reflection on the remaining surfaces and emits this light via the main side. Since the amount of emitted light decreases with increasing distance from the light source, the mesh size of the lattice structure must change as a function of the distance to the narrow side of the light-guiding plate with the light source located behind it.

In a lighting unit disclosed in U.S. Pat. No. 5,542,017 A, the light-guiding plate is provided with volume elements having different respective refractive indices to obtain uniform distribution of the light that is laterally emitted into the plate. Here, too, the degree of scattering must be adjusted as a function of the distance from the light source. The light-guiding plate can therefore not be produced independently of the respective dimensions of the lighting unit and the arrangement of the light sources.

A further drawback of edge-lit backlights is that the area available for coupling the light into the light-guiding plate is very small. As a result, reflectors are required to reflect the light emitted by the light source in a concentrated manner onto the respective narrow side of the light-guiding plate. If high luminous outputs are needed and a plurality of light sources is required, these light sources must be spaced as closely together as possible, which causes problems with heat dissipation. Finally, the lateral arrangement of the light source or sources requires relatively large outside dimensions of the lighting unit, which may considerably exceed the usable light-emitting surfaces.

### OBJECTS OF THE INVENTION

Therefore, it is an object of the present invention to provide an easily producible flat lighting unit having high luminous efficiency and compact dimensions.

### SUMMARY OF THE INVENTION

In accordance with the invention, this and other objects are attained by a lighting unit with a light-guiding plate having volume elements that scatter light, the volume elements having different respective refractive indices. Additionally, a lighting unit in accordance with the invention has a light-emitting surface formed on one side of the light-guiding plate and recesses formed on another side of the light-guiding plate, facing away from the side with the light-emitting surface. The recesses are distributed over the surface of the respective side of the light-guiding plate and light sources are located within each of the recesses.

The volume elements of the light-guiding plate, with their respective boundary surfaces, are statistically distributed within the light-guiding plate, such that the light guided in the plate is uniformly distributed by optical refraction and is coupled out of the light-guiding plate via the light-emitting surface. Light scattering is thus achieved by optical refraction rather than absorption, eliminating absorption losses. The light in the light-guiding plate not only reaches the light-emitting surface from the respective light source via the shortest possible route, but the light in the light-guiding plate can also propagate substantially parallel to the light-emitting surface, largely undamped, before being de-coupled from the plate by refraction at a point more remote from the corresponding light source.

To enhance the two-dimensional propagation of the light in the light-guiding plate by coupling-in the light accordingly, the light sources are arranged in the aforementioned recesses of the light-guiding plate. The lateral sides of these recesses can be provided with additional structures that couple the impinging light of the light sources into the light-guiding plate substantially in directions in which the surface of the plate extends (“superficial extent” of the plate). Through these measures, the light of each individual light source is distributed as far as possible across the entire light-emitting surface, so that if a single light source fails, the uniformity of the light distribution is not affected.

Finally, the individual light sources are kept free from vibrations due to being arranged in the recesses of the light-guiding plate. The overall height of the inventive lighting unit is determined essentially by the thickness of the light-guiding plate and can thus be kept very small. Independent of the respective dimensions of the lighting unit, the light-guiding plate can be produced as a molded part by casting or injection molding or, for instance, as a milled part. The part can subsequently be cut to the required dimensions. This enables simple mass production of the lighting unit.

To enable effective coupling into the light-guiding plate of those light components emitted by the light sources in the direction away from the light-emitting surface, a light-reflecting surface is preferably provided opposite the side of the light-guiding plate containing the recesses with the light sources. The light of the light sources that is not directly coupled into the light-guiding plate is reflected, preferably diffusely, on the light-reflecting surface, and then reaches the light-guiding plate. This coupling-in of the reflected light preferably occurs along the sides of the recesses in the light-guiding plate. For this reason, the sides of the recesses advantageously extend up to the reflecting surface.

The light-guiding plate can be directly adjacent to the light-reflecting surface, such that the distance between the light sources and the light-reflecting surface is also defined, resulting in a construction of an inventive lighting unit that is highly stable overall. The width of the opening of the recesses can increase in the direction of the light-reflecting surface, such that the reflected light reaches the light-guiding plate at a favorable angle and propagates substantially in the direction of the superficial extent of the plate.

Heat generated by the light sources can advantageously be dissipated via the light-reflecting surface. The light-reflecting surface is thereby preferably formed on the base plate of a light box, which holds the light-guiding plate with the light sources. This light box can be made, for instance, of sheet steel. The base plate is, for instance, painted white for diffuse light reflection. The interior surfaces of the light box adjacent to the narrow surfaces of the light-guiding plate are preferably metallized or mirrored, such that the light exiting along the narrow surfaces is reflected back into the light-guiding plate.

The vibration-free mounting of the light sources in the recesses of the light-guiding plate can be further enhanced by embedding the light sources with an intermediate layer of a transparent filler, particularly an adhesive. In this regard, any irregularities in the light emission, which may occur due to the very small distance between the light sources and the light-emitting surface compared with the distance between the light sources themselves, can be eliminated if the light scattering properties of the filler are such that it scatters the light to a greater degree than the light-guiding plate. Furthermore, the gap containing the filler located between the interior surfaces of the recesses and the circumferential surfaces of the light sources embedded therein, can be configured in such a way that the width of the gap increases with its proximity to the light-emitting surface of the light-guiding plate. As a result, the sum of the degree of light scattering of the transparent filler and the degree of light scattering of the light-guiding plate is approximately equal between the respective light source and any points located at various distances therefrom on the light-emitting surface.

Different light sources may be considered for the inventive lighting unit, such as light emitting diodes or flat fluorescent tubes, which are known, for instance, from the publication WO 92/02947. The light sources are preferably fluorescent tubes, while the recesses can be formed as parallel channels and the light-reflecting surface can be arranged at a predefined distance from the fluorescent tubes. The fluorescent tubes emit the light uniformly over the circumference of the tube. A portion of the light is coupled directly into the light-guiding plate, while the remaining light is diffusely reflected by the light-reflecting surface, which is spaced at a distance from the fluorescent tube, and then reaches the light-guiding plate.

In addition to affording the aforementioned advantages, embedding the fluorescent tubes in the channel-shaped recesses of the light-guiding plate has the further advantage that the fluorescent tubes heat up relatively quickly to their operating temperature to provide optimal luminous intensity. On the other hand, overheating of the fluorescent tubes is prevented because the tubes are arranged at a defined distance from the light-reflecting and heat-dissipating surfaces. This distance results in an appreciable temperature difference between the respective fluorescent tube and the heat-dissipating surface, which enhances the heat flow from the fluorescent tube to the heat-dissipating surface. In addition, because of this distance, the electrical parasitic capacitive coupling between the fluorescent tubes and the heat-dissipating surface is small, so that losses in the control of the fluorescent tubes are avoided.

Furthermore in this connection, each of two parallel fluorescent tubes are preferably electrically connected together in-series at one of their respective ends and connected to a tube driver circuit (DC/AC inverter) at their other end. This tube driver circuit is arranged at one of the narrow sides of the lighting device. This results in the shortest possible line connections between the fluorescent tubes and the tube driver circuit, such that the capacitive losses are minimized here as well. The tube driver circuit is preferably integrated in the lighting unit in that it is arranged in a lateral receiving slot of the light box.

### BRIEF DESCRIPTION OF THE DRAWINGS

The invention will now be described in greater detail with reference to the drawing figures in which,

FIG. 1 is a cross-sectional view of an embodiment of the inventive lighting unit with a light-guiding plate and fluorescent tubes,

FIG. 2 is a cross-sectional view of an embodiment of the inventive lighting unit illustrating embedding of one of the fluorescent tubes in a channel of the light-guiding plate,

FIG. 3 is a top view of an inventive lighting unit, and

FIG. 4 is a cross-sectional view of a further embodiment of the inventive lighting unit.

### DETAILED DESCRIPTION OF THE PREFERRED EMBODIMENTS

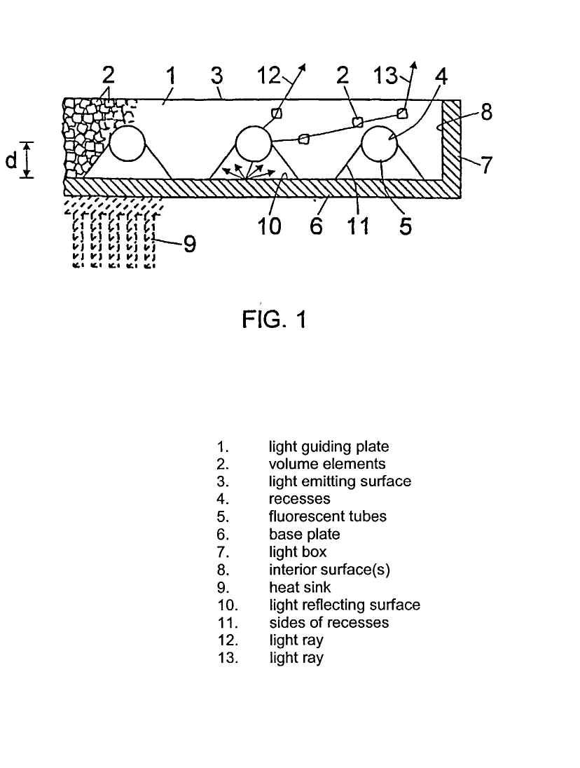

The lighting unit depicted in cross-section view in FIG. 1 has a light-guiding plate 1 comprising volume elements 2 with different optical refractive indices, which are only partially and roughly indicated here. Volume elements 2 can be formed, for example, by uniformly distributing particles of a first transparent material in another transparent base material through mixing or kneading. One main side of the light-guiding plate 1 forms the light-emitting surface 3 of the lighting unit. On the other side of the light-guiding plate, facing away from the main side, the light-guiding plate 1 is provided with recesses, here in the form of parallel channels 4, in which fluorescent tubes 5 are embedded as light sources. A portion of the circumferential surface of each of the fluorescent tubes 5, here about half, rests against the interior surface of the respective channel 4, while the remaining portion, in this case the other half, is exposed. At a predefined distance ‘d’ from the fluorescent tubes 5, a light-reflecting surface 10 is formed on a base plate 6 of a light box 7, which receives the light-guiding plate 1 with the fluorescent tubes 5 embedded therein. The interior surfaces 8 of light box 7 adjacent to the narrow surfaces of the light-guiding plate 1 are metallized. Light box 7 can be made, for instance, of sheet steel. The light-reflecting surface 10 is formed, for example, by a diffusely reflective white coating. Dissipation via base plate 6 of the heat generated by the fluorescent tubes 5 can be enhanced by a heat sink 9 arranged on the back thereof, as indicated here.

Here, the sides 11 of channels 4 extend up to the light-reflecting surface 10, such that the light-guiding plate 1 rests on the base plate 6. Distance ‘d’ between fluorescent tubes 5 and light-reflecting surface 10 is thus determined by the depth of channels 4. The width of the opening of channels 4 increases in the direction toward the light-reflecting surface 10, such that the sides 11 extend at an oblique angle in the area between fluorescent tubes 5 and light-reflecting surface 10. The light that is diffusely reflected by surface 10 thus reaches the light-guiding plate 1 at a favorable angle where it propagates substantially in the direction of the superficial extent of plate 1. Other embodiments of the sides 11, e.g., following a predefined curve, are also feasible. The surfaces of sides 11 can furthermore be roughened or structured in some other manner. The light emitted by the portion of the circumferential surface of the fluorescent tubes 5 adjacent to the interior surfaces of channels 4 is coupled directly into the light-guiding plate 1.

As illustrated by example in FIG. 1 using two light rays 12 and 13, the light is statistically uniformly dispersed by optical refraction at the boundary surfaces of volume elements 2 over substantially the entire superficial extent of light-guiding plate 1. Since there is almost no absorption, the light emitted by on of the fluorescent tubes 5 is very uniformly distributed at least in the area up to the next fluorescent tube or the one thereafter, so that the failure of a single fluorescent tube 5 is only marginally noticeable.

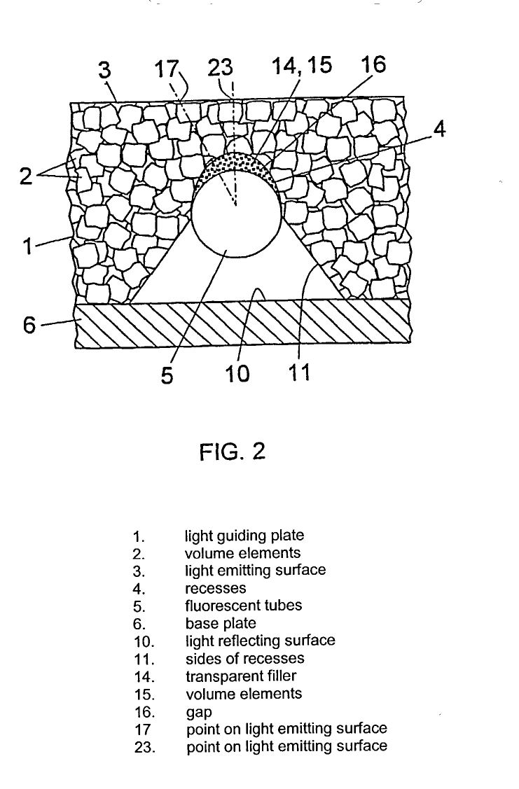

As shown in FIG. 2 by way of example, the fluorescent tubes 5 are embedded in channels 4 with an intermediate layer of a transparent filler 14, in this case an adhesive. Transparent filler 14 not only stabilizes the mounting of the fluorescent tubes 5 in channels 4 but also improves the coupling of the light into the light-guiding plate 1. Here, transparent filler 14, like light-guiding plate 1, comprises volume elements 15 with different refractive indices. However, because of the smaller volume elements 15 and/or use of other materials, the degree of light-scattering of filler 14 is greater than that of light-guiding plate 1. Here, channel 4 is shaped in such a way that a gap 16 receiving transparent filler 14 is formed between the interior surface of channel 4 and the circumferential surface of fluorescent tube 5. The width of this gap increases with its proximity to light-emitting surface 3. As a result, the scattering of the light is largely independent of the distance between different points 17, 23 on light-emitting surface 3 and fluorescent tube 5 even if the distance between fluorescent tube 5 and light-emitting surface 3 is very small.

The light emitted by fluorescent tube 5 via the portion of its circumferential surface that is exposed above channel 4 is diffusely reflected by the light-reflecting surface 10 and is coupled into the light-guiding plate 1 along sloped sides 11.

The fluorescent tubes 5 in accordance with this embodiment are cold cathode fluorescent tubes (CCFTs), which achieve maximum light efficiency at a defined operating temperature. Due to the partial embedding of fluorescent tubes 5 in channels 4 of light-guiding plate 1, this operating temperature is reached very quickly. On the other hand, overheating of fluorescent tubes 5 is prevented because the heat generated by the tubes is dissipated via base plate 6 of light box 7. Due to distance ‘d’ between fluorescent tubes 5 and base plate 6, there is a temperature difference created between the tubes 5 and base plate 6, which enhances the elimination of heat. Furthermore, due to distance ‘d’, parasitic capacitive coupling between fluorescent tubes 5 and conductive base plate 6 is very minor, so that the efficiency of the fluorescent tubes 5 is not affected in their high frequency control.

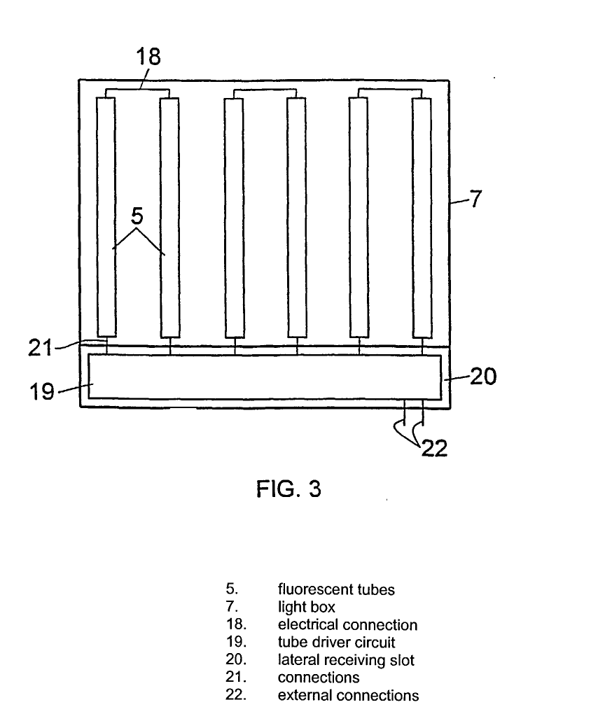

FIG. 3 is a top view of the lighting unit with light box 7 and fluorescent tubes 5 arranged parallel therein. Two light tubes 5 each are connected in-series at one end via an electrical connection 18 and are connected at their other end to a tube driver circuit 19. Tube driver circuit 19 in turn is arranged in a lateral receiving slot 20 of light box 7 and thus preferably forms an integral component of the lighting unit. Connections 21 between fluorescent tubes 5 and tube driver circuit 19 can be kept very short to minimize capacitive losses here as well. Tube driver circuit 19 is operated via external connections 22 at a low DC voltage, e.g. 24 V.

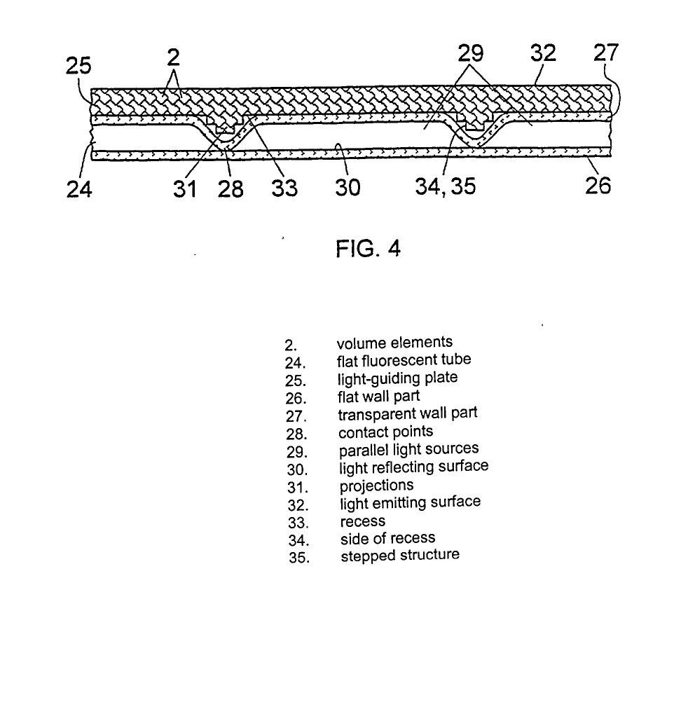

The embodiment of the inventive lighting unit shown in FIG. 4 includes a flat fluorescent tube 24 and a light-guiding plate 25. As in the above-described embodiment, light-guiding plate 25 comprises volume elements 2 with mutually differing refractive indices for scattering the light. Fluorescent tube 24 has both a flat wall part 26 and a transparent wall part 27 with wavy cross-section, which are superimposed and interconnected to each other at contact points 28 forming a gas-tight seal. The channels thus formed between the two wall parts 26 and 27 form mutually parallel light sources 29 in a single line and for this purpose contain a suitable gas filling and electrodes (not depicted). The wavy transparent wall part 27 is coated with a fluorescent substance, while the flat wall part 26 is provided with a light-reflecting surface 30 in the form of a coating.

The light-guiding plate 25 rests on the wavy transparent wall part 27 of fluorescent lamp 24. In the areas of contact points 28 between wall parts 26 and 27, it is provided with projections 31, which protrude into the gaps between respectively adjacent light sources 29. Light-guiding plate 25 thus comprises recesses 33 on the side facing away from its light-emitting surface 32 in which the individual light sources 29 are arranged. The sides 34 of recesses 33 or projections 31 are provided with structures 35, stepped in this embodiment, which couple the incident light emitted by the individual light sources 29 laterally into the light-guiding plate 25 substantially in the direction of the superficial extent of light-guiding plate 25. The light is reflected on the surfaces of stepped structure 35 that are parallel to light-emitting surface 32, and it is coupled into light-guiding plate 25 at the surfaces of stepped structure 35 that extend perpendicularly to the surface 32. Here, too, as in the embodiment shown in FIG. 2, the gap between the light-guiding plate 25 and the light sources 29 can contain a transparent filler.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. Alighting unit comprising:
a light-guiding plate having volume elements that scatter light, the volume elements having different respective refractive indices;
a light-emitting surface formed on a first side of said light-guiding plate;
recesses formed on a second side of said light-guiding plate facing away from the first side; and
respective light sources arranged within each of said recesses.

2. A lighting unit as claimed in claim 1, wherein said recesses are distributed across and under said light-emitting surface.

3. A lighting unit as claimed in claim 1, further comprising:
structures formed on lateral sides of said recesses, said structures coupling incident light from said light sources into said light-guiding plate substantially in a direction of a superficial extent of said guiding plate.

4. A lighting unit as claimed in claim 1, further comprising:
a light-reflecting surface facing the second side of said light-guiding plate, said light-reflecting surface being operable to reflect light generated by said light sources.

5. A lighting unit as claimed in claim 4, wherein sides of said recesses extend to said light-reflecting surface.

6. A lighting unit as claimed in claim 4, wherein the width of an opening of said recesses increases toward the light-reflecting surface.

7. A lighting unit as claimed in claim 4, further comprising:
a light box with a base plate on which said light-reflecting surface is formed, said light box receiving said light-guiding plate with said light sources.

8. A lighting unit as claimed in claim 7, further comprising:
metallized interior surfaces of said light box located adjacent to sides of said light-guiding plate.

9. A lighting unit as claimed in claim 1, further comprising:
an intermediate layer of a transparent filler material located in said recesses.

10. A lighting unit as claimed in claim 9, wherein said transparent filler material is an adhesive.

11. A lighting unit as claimed in claim 9, wherein said transparent filler material has a higher degree of light scattering ability than said light-guiding plate.

12. A lighting unit as claimed in claim 9, further comprising:
gaps formed between interior surfaces of said recesses and circumferential surfaces of said light sources, said gaps containing the filler material and the width of said gaps increasing with the proximity of said gaps to said light-emitting surface of said light-guiding plate.

13. A lighting unit as claimed in claim 1, wherein said light sources are fluorescent tubes.

14. A lighting unit as claimed in claim 13, wherein said recesses are configured as parallel channels and said light-reflecting surface is arranged at a defined distance from the fluorescent tubes.

15. A lighting unit as claimed in claim 14, wherein the parallel fluorescent tubes within the channels are electrically connected together in series at one end of each respective fluorescent tube and the other respective end of each of said fluorescent tube is connected to a tube driver circuit.

16. A lighting unit as claimed in claim 15, wherein the tube driver circuit is arranged in a lateral receiving slot of a light box, the light box having a base plate on which said light-reflecting surface is formed, the light box receiving said light-guiding plate with said light sources.

17. A light-guiding plate for a lighting unit, the light-guiding plate comprising:
a recessed area into which a light source is placed, the light source being partially exposed on one side toward a first surface of the light-guiding plate and the light source being partially embedded in the light-guiding plate on another side toward a second surface of the light-guiding plate;
volume elements having different respective indices of refraction, said volume elements being operable to reflect light emitted from the partially embedded portion of the light source; and
a reflective surface facing said recessed area, said reflective surface being operable to reflect light emitted from the partially exposed portion of the light source.

18. A light-guiding plate as claimed in claim 17, wherein the light source is embedded in said recessed area with a transparent filler material.

19. A light-guiding plate as claimed in claim 18, wherein the transparent filler material fills a significant gap between the light source and the volume elements.

20. A light-guiding plate as claimed in claim 17, wherein the light source is in contact with at least one of said volume elements.
